(19) United States
(12) Patent Application Publication
(10) Pub. No.: US 2011/0102368 A1
(43) Pub. Date: May 5, 2011

(54) FIELD DEVICE

(75) Inventor: Karl-Otto WIEMANN, Bad Oeynhausen (DE)

(73) Assignee: ABB Technology AG, Zurich (CH)

(21) Appl. No.: 12/940,586

(22) Filed: Nov. 5, 2010

(30) Foreign Application Priority Data
Nov. 5, 2009 (DE) 10 2009 052 074.0

(51) Int. Cl. G09G 5/00

(52) U.S. Cl. 345/174

(57) ABSTRACT

A field device includes a control device whose sensitive control surfaces are sampled capacitively. The control surfaces are arranged on an outside surface of a glass pane. The outside surface of the glass pane can be equipped with a hydrophobic nanocoating in front of the control surfaces of the field device, for protection against weather-dependent control errors, for example.

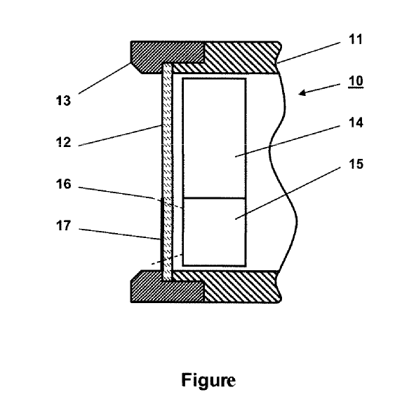

### RELATED APPLICATIONS

This application claims priority under 35 U.S.C. §119 to German Patent Application No. 10 209 052 074.0 filed in Germany on Nov. 5, 2009, the entire content of which is hereby incorporated by reference in its entirety.

### FIELD

The present dislcosure relates to a field device having a control device whose sensitive control surfaces are sampled capacitively.

### BACKGROUND INFORMATION

The document “Druckmessumformer 364”, 364 Pressure Measurement Transducer, from the ABB Company, document number PB/364-DE Rev. 2 dated November 2006 discloses a pressure measurement transducer for use in the field, in which the pressure measurement transducer is equipped with a display and a control device underneath the display. The display and the control device are concealed and protected against environmental influences, behind a glass pane. The control keys are operated by selective sampling of the capacitance via the key-like markings.

During practical operation, it has been found that surface moisture, such as raindrops, for example, on the glass pane are identified as a control process, and lead to inadvertent and unacceptable control errors of the measurement transducer. In this case, configuration changes have been observed, which lead to an incorrect measured-value output.

### SUMMARY

An exemplary embodiment of the present disclosure provides a field device which includes a glass pane, and a control device. The control device includes sensitive control surfaces which are configured to be sampled capacitively. The control surfaces are arranged on an outside surface of the glass pane. The outside surface of the glass pane is equipped with a hydrophobic nanocoating, at least in front of the control surfaces of the field device, for protection against weather-dependent control errors.

### BRIEF DESCRIPTION OF THE DRAWING

Additional refinements, advantages and features of the present disclosure are described in more detail below with reference to exemplary embodiments illustrated in the drawing, which illustrates a sectional view of an exemplary field device according to an embodiment of the present disclosure.

### DETAILED DESCRIPTION

Exemplary embodiments of the present disclosure provide a field device which reliably prevents inadvertent control operations caused by weather influences, for example.

The published article “Glas mit selbstreinigenden Eigenschaften” (translated as “Glass with self-cleaning characteristics”), first published online in Wikipedia on Jun. 7, 2006, discloses that the surface behavior can be changed in comparison to a normal glass by means of a coating, in such a way that it is difficult for dirt to become attached to the surface and, in the event of rain, accumulated dirt is generally washed off by water flowing away. This delays the time when the surface becomes dirty, and simplifies cleaning.

According to an exemplary embodiment of the present dislcosure, the outside of the glass pane is equipped with a hydrophobic nanocoating, for example, in front of the control keys of the field device. The water-repellent effect of this coating impedes the formation of water drops, which can be sampled capacitively, in the area of the key-like markings, and prevents inadvertent operation of the field device.

According to an exemplary embodiment of the present disclosure, the entire outside of the glass pane can be equipped with a hydrophobic nanocoating. According to this exemplary arrangement, the coating in any case covers the sensitive area in front of the control keys of the field device, irrespective of the respective installation position of the glass pane.

The glass pane is held in a frame. According to an exemplary embodiment, the frame surfaces which are adjacent to the glass pane can be equipped with a hydrophobic nanocoating.

Exemplary embodiments of the present dislcosure are explained in more detail below with reference to the drawing. The drawing shows a section view of an exemplary field device 10, illustrating components of the field device 10 for understanding the illustrated exemplary embodiment of the present dislcosure. The field device 10 includes a substantially cylindrical housing 11 in which functional elements can be accommodated. The side of the housing 11 facing the operator is transparent. For example, the side of the housing 11 facing the operator can be in the form of a glass pane 12. The glass pane 12 is held in a frame 13 which is joined to the housing 11. For example, the glass plane 12 can be screwed to the housing 11 in the form of a cap nut. A display 14 and a control device 15 are arranged in the interior of the housing 11, behind the glass pane 12.

The control device 15 is configured to selectively sample the capacitance via key-like markings in a sensitive area 16. The key-like markings in the sensitive area 16 can constitute control surfaces of the control device 15. According to an exemplary embodiment of the present dislcosure, the outside of the glass pane 12 can be equipped with a hydrophobic nanocoating 17, for example, in the sensitive area 16. The nanocoating 17 can extend over the entire outside of the glass pane 12.

According to an exemplary embodiment, the nanocoating 17 can include two layers, wherein the first layer provides the connection between the existing surface of the glass pane 12 and the new, nanostructured layer 17.

According to an exemplary embodiment of the present dislcosure, those surfaces of the frame 13 which are adjacent to the glass pane 12 are equipped with a hydrophobic nanocoating 17. This exemplary arrangement prevents water from accumulating in the gap between the glass pane 12 and the frame 13.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

### LIST OF REFERENCE SYMBOLS

10 Field device

11 Housing

12 Glass pane

13 Frame

14 Display

15 Control device

16 Sensitive area

17 Coating

What is claimed is:

1. A field device comprising:
a glass pane; and
a control device having sensitive control surfaces which are configured to be sampled capacitively, wherein the control surfaces are arranged on an outside surface of the glass pane,
wherein the outside surface of the glass pane is equipped with a hydrophobic nanocoating, at least in front of the control surfaces of the field device, for protection against weather-dependent control errors.

2. The field device as claimed in claim 1, comprising:
a frame for holding the glass plane,
wherein surfaces of the frame which are adjacent to the glass pane are equipped with a hydrophobic nanocoating.

3. The field device as claimed in claim 1, wherein the control device is arranged adjacent to a surface of the glass plane opposite to the outside surface of the glass plane on which the hydrophobic nanocoating is equipped.

4. The field device as claimed in claim 3, comprising:
a display device arranged adjacent to the control device near the surface of the glass plane opposite to the outside surface of the glass plane on which the hydrophobic nanocoating is equipped.

5. The field device as claimed in claim 4, comprising:
a frame for holding the glass plane; and
a housing into which the control device and the display device are arranged.

6. The field device as claimed in claim 5, wherein surfaces of the frame which are adjacent to the glass pane are equipped with a hydrophobic nanocoating.

7. The field device as claimed in claim 1, wherein the hydrophobic nanocoating includes a first layer constituting a nanostructured layer, and a second layer connecting between the first layer and the outside surface of the glass plane.
